(19) United States
(12) Patent Application Publication
(10) Pub. No.: US 2025/0315831 A1
(43) Pub. Date: Oct. 9, 2025

(54) METHOD, SYSTEM AND APPARATUS FOR VERIFYING IDENTITIES OF PARTICIPANTS IN BLOCKCHAIN TRANSACTIONS

(71) Applicant: Dennis Lyon, Oceanside, CA (US)

(72) Inventor: Dennis Lyon, Oceanside, CA (US)

(21) Appl. No.: 18/626,641

(22) Filed: Apr. 4, 2024

(51) Int. Cl. G06Q 20/40; G06Q 20/02; G06Q 20/38

(52) U.S. Cl. CPC G06Q 20/4014; G06Q 20/02; G06Q 20/3825; G06Q 20/3829

(57) ABSTRACT

A method, system and apparatus for verifying an identity of a participant of an intended blockchain transaction. Prior to sending a blockchain transaction, a personal communication device generates and transmits a verification request to a third-party trust manager, requesting that the third-party trust manager verify the identity of a participant of the intended blockchain transaction. The third-party trust manager verifies whether the participant is who the participant claims to be, and sends a verification response to the personal communication device indicating such. The personal communication device transmits the intended blockchain transaction to a blockchain network only when the participant's identity was verified by the third-party trust manager.

### BACKGROUND

### I. Field of Use

The present invention relates to blockchain technology and more specifically to verifying the identity of participants of blockchain transactions.

### II. Description of the Related Art

In recent years, distributed ledger technology, sometimes referred to herein as “blockchain” technology, has exploded onto the scene, promising to provide secure online transactions while eliminating middlemen. The technology draws its power from peers—or nodes—on a blockchain network to verify, process, and record all transactions across the system. A distributed ledger is formed as a result of verifications of the transactions by the nodes. This ledger is never stored, but rather exists on the “chain” supported by thousands or millions of nodes simultaneously. Thanks to encryption and decentralization, blockchain's database of transactions is incorruptible, and each record is easily verifiable. The network cannot be taken down or influenced by a single party because it doesn't exist in one place. Well-known implementations of blockchain technology include the Bitcoin and Ethereum blockchain networks.

In order to execute transactions on a blockchain network, such as to transfer cryptocurrency, purchase goods or services, to participate in smart contracts, each transaction is validated by each node in a blockchain network. If more than half of the nodes agree that the transaction is valid, a transaction is published as a block on the blockchain. Validation comprises the use of public key cryptography, where transactions are encrypted by a transaction initiator using a public key owned by a participant of a transaction, and digitally signed using a private key of the transaction initiator to ensure that the transaction was, in fact, initiated by the entity associated with a public key corresponding to the initiator's private key.

While it is almost impossible to record bogus transactions on a blockchain network, i.e. “double spending”, there is no way for transaction participants to know whether the opposing party in a transaction is who they say they are. Blockchain networks only validate that the keys used to encrypt and sign transactions are valid—not who own the keys. Therefore, it would be useful to provide a way to verify the identity of participants in blockchain transactions, without compromising the inherent anonymity that blockchain networks provide.

### SUMMARY

The present disclosure describes embodiments of a method, system and apparatus for verifying an identity of an intended participant of a blockchain transaction. In one embodiment, a method is described, performed by a personal computing device, for verifying identities of participants in blockchain transactions, comprising constructing a blockchain transaction, the blockchain transaction comprising a non-verified identity of an intended participant of the transaction, prior to sending the blockchain transaction to a blockchain network, sending a verification request to a third-party trust manager, the verification request comprising the non-verified identifier of the intended participant, receiving a verification response from the third-party trust manager, and sending the blockchain transaction to the blockchain network only when the verification response indicates that the intended participant's identity has been verified by the third-party trust manager.

In other embodiment, an apparatus is described for verifying an identity of a intended participant of a blockchain transaction, comprising, a network interface, a non-transitory memory for storing processor-executable instructions, and a processor coupled to the network interface and the non-transitory memory for executing the computer-executable instructions that cause the processor to construct a blockchain transaction, the blockchain transaction comprising a non-verified identity of the intended participant, prior to sending the blockchain transaction to a blockchain network, send, via the network interface, a verification request to a third-party trust manager, the verification request comprising the non-verified identifier of the intended participant, receive, via the network interface, a verification response from the third-party trust manager, and send, via the network interface, the blockchain transaction to the blockchain network only when the verification response indicates that the intended participant's identity has been verified by the third-party trust manager.

In yet another embodiment, a system is described, for verifying identities of participants of a blockchain transaction, comprising, a personal communication device and a third-party trust manager, wherein the system verifies a participant of a blockchain transaction by constructing a blockchain transaction by the personal communication device, the blockchain transaction comprising a non-verified identity of an intended participant of the transaction, prior to sending the blockchain transaction to a blockchain network, sending a verification request to the third-party trust manager by the personal communication device, the verification request comprising the non-verified identifier of the intended participant, receiving, by the third-party trust manager, the verification request from the personal communication device, verifying, by the third-party trust manager, that the intended participant of the blockchain transaction is who the intended participant claims to be, sending, by the third-party trust manager, a verification response comprising an indication whether or not the intended participant of the blockchain transaction is who the intended participant claims to be, receiving the verification response by the personal communication device, and sending the blockchain transaction to the blockchain network only when the verification response indicates that the intended participant's identity has been verified by the third-party trust manager.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a functional block diagram of one embodiment of a system for verifying identities of participants in blockchain transactions;

FIG. 2 is a functional block diagram of one of the personal communication devices as shown in FIG. 1; and

FIGS. 3A-3B represent a flow diagram illustrating one embodiment of a method, performed by one of the personal communication devices as shown in FIG. 1, for verifying identities of participants in blockchain transactions.

### DETAILED DESCRIPTION

Various embodiments of a method, system and apparatus are described for verifying identities of participants of blockchain transactions. Embodiments of the present invention seek to improve the technology behind blockchain by allowing a transaction initiator to verify a recipient's identity prior to sending a blockchain transaction to a blockchain network, while also preserving anonymity of the participant(s) in a blockchain transaction.

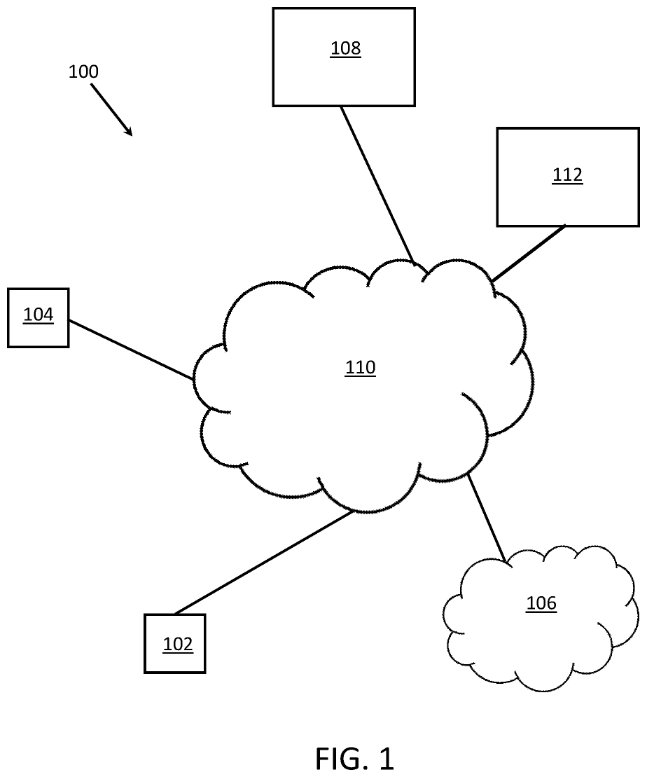

FIG. 1 is a functional block diagram showing one embodiment of a system 100 for verifying the identity of participants of blockchain transactions. Shown is personal computing device (PCD) 102, personal computing device (PCD) 104, blockchain network 106, third-party trust manager 108, wide-area network 110 and another third-party trust manager 112. It should be understood that blockchain network 106 may additionally comprise PCDs, such as PCD 102 and PCD 104 operating as nodes of blockchain network 106.

PCD 102 and PCD 104 each comprise an electronic, network-compatible computing device capable of communicating over wide-area network 110 with other entities, such as PCD 104, blockchain network 106 and third-party trust managers 108 and 112. Each PCD is also capable of executing a variety of applications or “apps” for transacting with other entities in system 100, such as payment apps, such as Venmo and PayPal, and digital wallet apps, such as Apple Wallet, Google Wallet, and Cash App that store cryptocurrency in a “digital wallet” and allow transactions, such as cryptocurrency transfers between participants, purchasing goods and services, participating in smart contracts, etc. using well-known cryptographic and blockchain techniques. Each PCD may comprise a smart phone, wearable device (such as a smart watch), tablet computer, laptop computer, desktop computer, etc. It should be understood that although only two PCDs are shown in FIG. 1, in practice, thousands or even millions of PCDs may participate in transactions managed by blockchain network 106.

Blockchain network 106 comprises a plurality of computing “nodes” that form a distributed, digital computing system for recording the transaction of assets in which the transactions and their details are recorded by the plurality of nodes in cryptographic blocks that are “chained” together using well-known blockchain techniques. Unlike traditional databases, blockchain network 106 has no central data store or administration functionality. Blockchain network 106 in general, comprises technological infrastructure and protocols that enable the simultaneous access, validation and updating of digital records. In blockchain network 106, each node processes and verifies each transaction, thereby generating a record of each transaction and creating a consensus on a transaction's veracity. While reference is made herein to blockchain network 106, other blockchain networks may be used as well, such as the well-known Ethereum blockchain network.

Each of third-party trust managers 108 and 112 comprise a bank, government agency, or some other public or private entity that initially establishes a trusted relationship with its customers, i.e., determine that each customer is who they claim to be and, after verification, serve as a trusted third-party for blockchain transactions involving one or more of their verified customers. The initial trust relationship may be may be established using traditional verification techniques, such as by requiring a potential customer to physically visit a branch location and provide one or more types of trusted identification in order to open an account, such as a Social Security card, driver's license, passport, birth certificate, a fingerprint, etc. The initial trust relationship may also be established online via a PCD in communication with 108 via wide-area network 110. In this case, third-party trust manager 108 or 112 may query a potential customer to enter identifying information, such as a name, date of birth, address, driver's license number, Social Security number, passport number, etc., and then third-party trust manager 108 or 112 verifies the identification information by contacting one or more trusted authorities, such as a department of motor vehicles, a Social Security Administration, the US Department of State, one or more credit bureaus, etc.

Wide-area network 110 comprises one or more digital communication networks, such as the Internet, cellular data networks, satellite communication networks, etc., configured to allow the various entities shown in FIG. 1 to communicate with each other over large geographical distances. Such wide-area networks are well-known in the art.

System 100 may verify the identity of one or more persons participating in a blockchain transaction. Each person wishing to participate in system 100 may pre-register with third-party trust manager 108 and/or 112 by providing proof of who they say they are to third-party trust manager 108 and/or 112, and each third-party trust manager manually and/or electronically verifies that each person is or is not who they claim to be. When a person is verified successfully, identification information of the person may be stored in a database of third party trust manager 108. In other embodiments, some or all participants of blockchain transactions are not pre-registered with a third-party trust manager. In this embodiment, a third-party trust manager may verify one or more participants of a blockchain transaction just before the blockchain transaction is sent to a blockchain network for recordation.

A transaction is typically initiated by an individual or entity controlling a PCD in system 100. For example, Person A, operating PCD 102, may want to transfer 0.01 Bitcoin to Person B, operating PCD 104. At least person B may have been pre-registered with third-party trust manager 108 by virtue of opening a checking account with third-party trust manager 108. Each of PCD 102 and PCD 104 may execute an app for transferring cryptocurrencies, purchasing goods and services using cryptocurrency, exchanging cryptocurrencies, and generally maintaining one or more accounts for each of Person A and Person B, respectively. In this example, Person A initiates a blockchain transaction via the app and provides certain details about the transaction, such as an identification of Person A, an identification of Person B, and a type and amount of cryptocurrency, in this example, bitcoin, to be transferred from Person A to Person B. In a typical blockchain transaction, Person A and Person B are identified by a public key belonging to each person, respectively. The public key of each person is typically generated by a digital wallet app running on each person's respective PCD in system 100, which also generates a respective private key, typically upon initiation of an account managed by a digital wallet. In other cases, a public/private cryptographic key pair may be provided by a third-party entity and provided to a PCD via wide-area network 110.

In addition to the information described above, a blockchain transaction typically comprises a digital signature comprising a hash of the above-described information and then the hash is typically encrypted with the private key belonging to Person A.

In any case, before the blockchain transaction is sent by PCD 102 to blockchain network 106, PCD 102 sends a verification request to third-party trust manager 108 and/or 112 via wide-area network 110. The verification request is typically encrypted by PCD 102 via the digital wallet using a public key associated with third-party trust manager 108. The verification request is also typically digitally signed using Person A's private key.

When the verification request is received by third-party trust manager 108 and/or 112 it decrypts the digital signature using Person A's public key to obtain a 256-bit number. Then, a hash function, such as SHA256, is applied to the transaction information to get another 256-bit number. Third-party trust manager 108 then compares the two numbers and, if a match is found, third-party trust manager 108 knows that the verification request was actually initiated by Person A and that the information in the verification request has not been changed. It should be understood that other cryptographic techniques could be used to verify that Person A is who he/she claims he/she is and that the verification data has not changed, as well-known in the art.

After the verification request has been decrypted and the digital signature verified, third-party trust manager 108 and/or 112 may compare the identity of another participant in system 100, such as a recipient of cryptocurrency of the blockchain transaction, to a database maintained by third-party trust manager 108 in order to determine if the other participant is listed as a trusted and pre-registered entity. If so, third-party trusted manager 108 sends a verification response to PCD 102, indicating that the recipient is or is not who they claim to be. If the verification response indicates that the recipient is who they claim to be, the digital wallet app running on PCD 102 transmits the transaction to blockchain network 106 via-wide area network 110. From there, the transaction is processed by blockchain network 106 in accordance with well-known techniques. If the recipient is not listed as a trusted and preregistered entity in the database maintained by third-party trust manager 108 and/or 112, third-party trust manager 108 and/or 112 may either indicate in the verification response that the recipient was not verified, or, in another embodiment, one third-party trust manager may send a second verification request to another third-party trust manager with the recipients identification, requesting that the other third-party trust manager verify the recipient's identity. If the other third-party trust manager verifies the recipient's identity, such as by comparing the identity in the second verification request to a database of pre-verified entities managed by a other third-party trust manager, the other third-party trust manager sends a verification response to the third-party trust manager that sent the verification request and forwards the verification response to PCD 102.

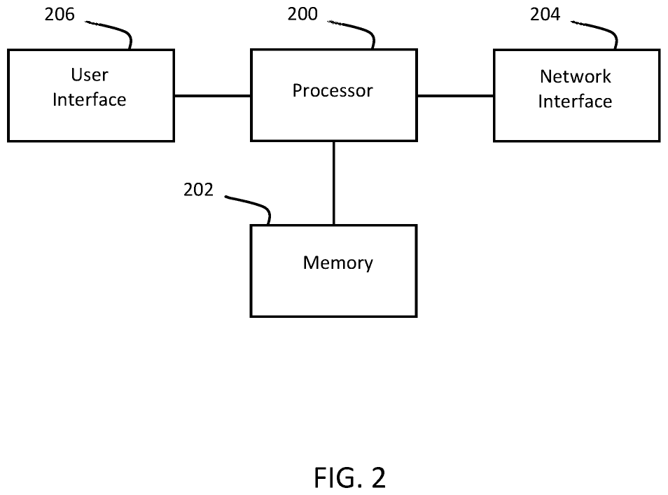

FIG. 2 is a simplified, functional block diagram of a PCD, comprising processor 200, non-transitory memory 202, network interface 204 and user interface 206. It should be understood that FIG. 2 does not include ancillary functional blocks, such as a battery, specialized wireless communication technology, etc.

Processor 200 is configured to provide general operation of a PCD by executing processor-executable instructions stored in memory 202, for example, executable computer code. Processor 200 typically comprises one or more general or specialized microprocessors, microcontrollers, and/or customized ASICs, selected based on computational speed, cost, size, power consumption, and other factors relevant to a particular PCD. After processor 200 bas been programmed with the processor-executable instructions, it may become a specialized processor capable of performing one or more new and non-obvious methods as described later herein.

Memory 202 is coupled to processor 200 and comprises one or more non-transitory electronic, digital information storage devices, such as static and/or dynamic RAM, ROM, flash memory, or some other type of electronic, optical, or mechanical memory device. Memory 202 is used to store processor-executable instructions for operation of each PCD, respectively. It should be understood that in some embodiments, a portion of memory 202 may be embedded into processor 200 and, further, that memory 202 excludes propagating signals. Memory 202 may additionally store information pertinent to one or more apps running on a PCD, such as information relating to a digital wallet, such as a public/private key pair, one or more balances of one or more cryptocurrencies owned by a user of a PCD, etc.

Network interface 204 is coupled to processor 200, comprising circuitry for sending and receiving digital data to/from other entities in system 100 via wide-area network 110. For example, network interface 204 may comprise circuitry and firmware for sending and receiving digital data in the form of digital data packets, for example, in association with a TCP/IP protocol. Such circuitry and/or firmware is well known in the art.

User interface 206 is coupled to processor 200, comprising well-known elements to receive and provide information to a user of a PCD. For example, user interface 206 may comprise a touch screen device, a keypad, keyboard, microphone, etc.

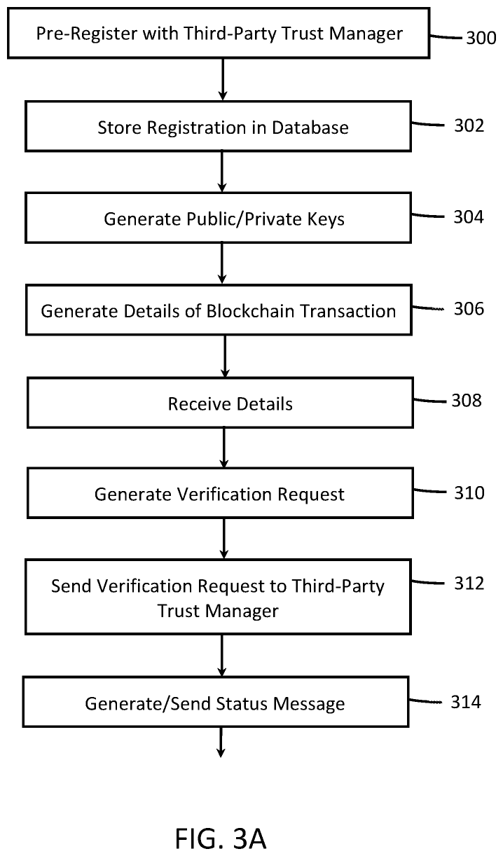

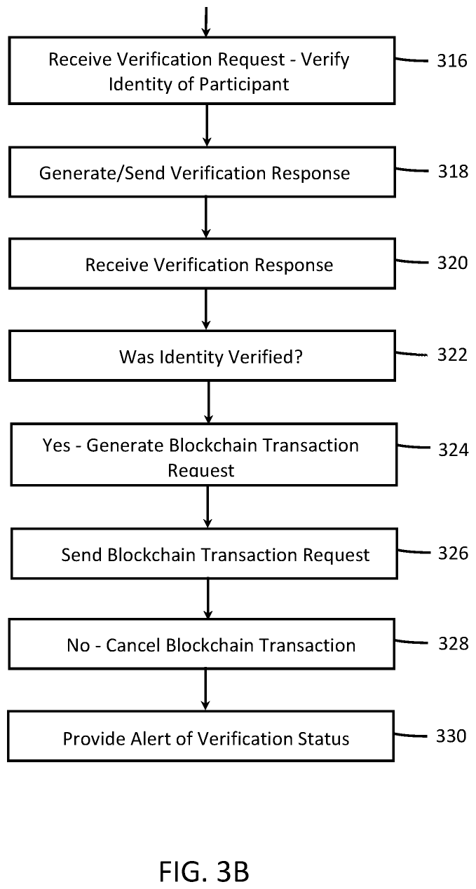

FIG. 3 is a flow diagram illustrating one embodiment of a method, in this case performed by PCD 102 and third-party trust manager 108 for verifying identities of one or more participants of a blockchain transaction. It should be understood that in some embodiments, not all of the steps shown in FIG. 3 are performed, and that the order in which the steps are carried out may be different in other embodiments. It should be further understood that some minor method steps have been omitted for purposes of clarity. The entity operating PCD 102 and initiating a blockchain transaction may be referred to herein as an initiator, while in entity operating PCD 104 and is another party to a blockchain transaction may be referred to herein as a recipient. Either the initiator or the recipient may be referred to herein as a “participant” of a blockchain transaction.

At block 300, an entity associated with PCD 102, such as a person or an organization, pre-registers with third-party trust manager 108. Pre-registration may comprise a person or entity opening a new account with third-party trust manager 108 or pre-registering with third-party trust manager 108 specifically to participate in blockchain transactions in system 100, and variations thereof. Verification of identity is performed by third-party trust manager 108 by ensuring that an intended participant of an intended blockchain transaction has pre-registered with one or more third-party trust managers. In another embodiment, a third-party trust manager may verify the identity of the intended recipient of an intended blockchain transaction by verifying one or more identification credentials, such as a driver's license, Social Security card, bank statement, utility statement, a cryptographically verifiable credential or other such identification documents provided by initiator of an intended blockchain transaction. In some embodiments, pre-registration with third-party trust manager 108 is required to participate in blockchain transactions with other pre-registered persons. In other embodiments, registration with third-party trust manager 108 may be accomplished “on-the-fly” as a blockchain transaction is being prepared. For example, when third-party trust manager 108 receives a verification request from PCD 102, third-party trust manager 108 may contact an entity associated with PCD 104 as the intended recipient of the blockchain transaction, using information contained within the verification request and ask the intended recipient to provide one or more identification credentials to third-party trust manager 108. Third-party trust manager 108 then verifies the credential(s) provided by the intended recipient by contacting one or more public or private credential providers.

Other entities of system 100, such as an entity associated with PCD 104, may pre-register with third-party trust manager 108 and/or, in some embodiments, one or more other third-party trust managers, one of which is shown in FIG. 1 as third-party trust manager 112. Typically, thousands or even millions of entities pre-register with one or more third-party trust managers so that they can participate in blockchain transactions with one another.

At block 302, after verifying an entity, third-party trust manager 108/112 may store a record of the verification in a database associated with a trust manager. For example, a name, address, account number, or some other information associated with a verified person is stored in a database of verified entities. The database of verified entities may be used to verify participants of a blockchain transaction.

At block 304, processor 200 of PCD 102 may generate a public/private key pair for a person or entity associated with PCD 102, from processor-executable instructions stored in memory 202. For example, the processor-executable instructions may comprise instructions that provides a digital wallet to the person or entity associated with PCD 102, and may generate such a key pair for use in conducting transactions on blockchain network 106. Each PCD in system 100 may generate a public/private key pair for an associated person or entity operating a respective PCD. In some embodiments, each processor of each PCD in system 100 may provide a respective public key to a public key repository via network interface 204 and wide-area network 110, such as a OpenPGP key server, in order to widely disseminate the public keys in anticipation for future blockchain transactions.

At block 306, a person or entity associated with PCD 102 may wish to transact business with a person or entity associated with PCD 104. For example, the person associated with PCD 102 may wish to swap cryptocurrencies, send cryptocurrency or purchase goods or services from the person or entity associated with PCD 104. The person or entity associated with PCD 102 may provide details of an intended blockchain transaction to the app running on PCD 102. For example, a person may specify a type of transaction, an amount of cryptocurrency, money or other monetary value to be provided to the person or entity associated with PCD 104 and one or more identifications of the person or entity associated with PCD 104. The identity of the person or entity associated with PCD 104 may comprise the person or entity's public key, a name, an account number, or some other unique identifier. One or more identifiers may be provided, such as a public key and an alleged name associated with the public key.

At block 308, processor 200 receives the details of the desired blockchain transaction via user interface 106 of PCD 102, such as a keypad, keyboard, touchscreen, microphone, etc.

At block 310, in response to receiving the intended blockchain transaction details, processor 200 generates a verification request for verifying an identity of at least the intended recipient of the intended blockchain transaction, in this case, the person or entity associated with PCD 104. In one embodiment, the verification request additionally comprises an identification of the initiator, such as a public key, a name, an account number, etc. In some embodiments, the verification request is encrypted using a public key associated with third party trust manager 108 and digitally signed using a private key of the initiator, using techniques well-known in the art.

In some embodiments, the verification request may also contain other information, such as contact information of the intended recipient used by third-party trust manager 108 verify the identity of the intended recipient upon receipt of the verification request and/or contact information of a third-party trust manager where the intended recipient has pre-registered, such as third-party trust manager 112, in an embodiment where third-party trust manager 112 verifies the identity of the intended recipient and notifies either PCD 102 or third-party trust manager 108 of the result.

At block 312, the verification request is sent to third-party trust manager 108 by processor 200 via network interface 204 and wide area network 110.

At block 314, in one embodiment, processor 200 generates and sends a status message to the intended recipient indicating that the verification request has been sent to third-party trust manager 108.

At block 316, third-party trust manager 108 receives the verification request and, in response, verifies the identity of the intended recipient of the intended blockchain transaction as provided in the verification request. In some embodiments, third-party trust manager 108 first decrypts the verification request using the private key associated with third-party trust manager 108, and verifies that the initiator actually sent the verification request using the initiators public key. In some embodiments, third-party trust manager 108 additionally verifies the identification of the blockchain transaction initiator, i.e. the person or entity operating PCD 102, such as by comparing identification information of the transaction initiator as provided in the verification request to a database of pre-verified persons or entities.

In one embodiment, in order to verify the intended recipient's identity, third-party trust manager 108 automatically compares the intended recipient's unique identifier(s) contained in the verification request to a database of pre-verified persons or entities, established as described in block 300, above. In another embodiment, in order to verify the intended recipient's identity, third-party trust manager 108 may attempt to contact the intended recipient after receipt of the verification request. This may occur after third-party trust manager 108 fails to find the person or entity in its database of pre-verified persons or entities. In this embodiment, the verification request may additionally comprise contact information of the intended recipient, such as an email address, phone number, IP address, etc. The intended recipient may respond to third-party trust manager 108 with one or more proof of identification, such as a driver's license, passport, account number, birth certificate, etc. via wide area network 110. Third-party trust manager 108 may then attempt to verify the identity of the intended recipient by, for example, contacting a Department of Motor Vehicles to verify an alleged driver's license provided by the intended participant.

In yet another embodiment, in order to verify the intended recipient's identity, third-party trust manager 308 may transmit a second verification request to another third-party trust manager, such as third-party trust manager 112. This may occur if a match is not found between the identification information of the intended participant in the original verification request and information in the database of pre-verified persons or entities. In this case, the second verification request may comprise an identification of third-party trust manager 112 and the identification information of the intended recipient. The second verification request may then be sent to one or more other third-party trust managers. In some embodiments, the original verification request may comprise information that identifies third-party trust manager 112 as an entity that has pre-verified the intended participant, such as a URL, IP address, name, address, ABA routing number, or some other identification information. In any case, the second verification request is sent to one or more other third-party trust managers via wide area network 110. The second verification request is processed similar to the first verification request by third-party trust manager 112, i.e., either determining whether the intended participant has pre-registered with third-party trust manager 112, or by third-party trust manager 112 contacting the intended recipient and verifying the intended participant's identification information at that time. After verification, one of the one or more other third-party trust managers sends a verification response to third-party trust manager 308, indicating whether or not the intended person or entity is who he/she/it claims to be.

In any case, at block 318, third-party trust manager 108 generates and sends a verification response to PCD 102 after verifying the intended recipient's identification, or having another third-party trust manager verify the intended participant's identification. The verification response may, additionally or alternatively, provide an indication that the transaction initiator has been verified, or that intended blockchain transaction is, or is not, permitted to be sent to blockchain network 106.

At block 320, the verification response is received by processor 200 of PCD 102 via network interface 204 and wide area network 110.

At block 322, processor 200 determines whether the intended recipient's identity has been verified by processing the verification response from third-party trust manager 108.

At block 324, if third-party trust manager 108 or third-party trust manager 112 has verified that the intended recipient has either been verified, i.e., pre-registered with third-party trust manager 108 or 112, or that the intended recipient has been verified by third-party trust manager 108 or 112 on the fly, processor 200 generates a blockchain transaction request, i.e., an identification of the intended recipient, an identification of the initiator, the type and amount of monetary value to be transferred, etc., as is well-known in the art. In one embodiment, both the initiator and the intended recipient must be verified before the blockchain transaction request can be sent to blockchain network 106.

At block 326, processor 200 sends the blockchain transaction request to blockchain network 106 via network interface 204 and wide area network 110.

At block 328, if third-party trust manager 108 was unable to verify the identity of the intended participant or, in some embodiments, the initiator, processor 200 may cancel the intended blockchain transaction, for example, by deleting a previously-created blockchain transaction request.

At block 330, processor 200 may alert the person or entity associated with PCD 102 that the verification process has failed, and that the intended blockchain transaction will not occur. In one embodiment, processor 200 provides an alert via the user interface of PCD 102. In another embodiment, in addition or alternative to alerting a user via the user interface, processor 200 may generate and send an alert to a remote entity via network interface 204 and wide area network 110. This may comprise an email, text, automated voice phone call or some other means. In one embodiment, processor 200 may additionally send a status message to the intended recipient that the intended blockchain transaction will not occur due to one or both of the initiator or the intended recipient failing to be verified by third-party trust manager 108 and/or 112.

In the description above, certain aspects and embodiments of the invention may be applied independently and some of them may be applied in combination as would be apparent to those of skill in the art. For the purposes of explanation, specific details are set forth in order to provide a thorough understanding of embodiments of the invention.

The above description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the embodiments as set forth in the appended claims.

Although specific details are given to provide a thorough understanding of at least one embodiment, it will be understood by one of ordinary skill in the art that some of the embodiments may be practiced without disclosure of these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a method, a process or an algorithm performed by a processor, which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. The terms “computer-readable medium”, “memory”, “storage medium”, and “memory” includes, but is not limited to, portable or non-portable electronic memories, optical storage devices, and various other mediums capable of storing, containing, or carrying instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, RAM, ROM, flash memory, solid state disk drives (SSD), etc. A computer-readable medium or the like may have stored thereon code and/or processor-executable instructions that may represent a method, algorithm, procedure, function, subprogram, program, routine, subroutine, or any combination of instructions, data structures, or program statements.

Furthermore, embodiments may be implemented by hardware, software, firmware, middleware, microcode, hardware description languages, or any combination thereof. When implemented in software, firmware, middleware or microcode, the program code, i.e., “processor-executable code”, or code symbols to perform the necessary tasks (e.g., a computer-program product) may be stored in a computer-readable or machine-readable medium. processor(s) may perform the necessary tasks.

What is claimed is:

1. A method for verifying identities of participants in blockchain transactions by a personal computing device, comprising:
constructing a blockchain transaction, the blockchain transaction comprising a non-verified identity of an intended participant of the transaction;
prior to sending the blockchain transaction to a blockchain network, sending a verification request to a third-party trust manager, the verification request comprising the non-verified identifier of the intended participant;
receiving a verification response from the third-party trust manager; and
sending the blockchain transaction to the blockchain network only when the verification response indicates that the intended participant's identity has been verified by the third-party trust manager.

2. The method of claim 1, wherein the verification request is encrypted with a public key associated with the third-party trust manager.

3. The method of claim 1, wherein the verification request is digitally signed with a private key associated with an initiator of the blockchain transaction.

4. The method of claim 3, further comprising:
pre-registering the initiator with the third-party trust manager.

5. The method of claim 4, wherein pre-registering the initiator comprises:
proving at least one identification credential belonging to the initiator to the third-party trust manager before the initiator is permitted to send the blockchain transaction to the blockchain network.

6. The method of claim 1, further comprising:
receiving the verification response from the third-party trust manager indicating that the intended participant is not listed in a database of pre-verified entities; and
canceling the blockchain transaction in response to the verification response indicating that the intended participant is not listed in a database of pre-verified entities.

7. The method of claim 1, further comprising:
sending a status message to the intended participant indicating that verification of the intended participant is in progress.

8. The method of claim 7, further comprising:
sending a second status message to the intended participant after receipt of the verification response, the second status message indicating whether the intended participant was verified or not.

9. The method of claim 1, wherein the verification response comprises a verification of the intended participant from a second third-party trust manager in communication with the third-party trust manager.

10. An apparatus for verifying an identity of a intended participant of a blockchain transaction, comprising:
a network interface;
a non-transitory memory for storing processor-executable instructions; and
a processor coupled to the network interface and the non-transitory memory for executing the computer-executable instructions that cause the processor to:
construct a blockchain transaction, the blockchain transaction comprising a non-verified identity of the intended participant;
prior to sending the blockchain transaction to a blockchain network, send, via the network interface, a verification request to a third-party trust manager, the verification request comprising the non-verified identifier of the intended participant;
receive, via the network interface, a verification response from the third-party trust manager; and
send, via the network interface, the blockchain transaction to the blockchain network only when the verification response indicates that the intended participant's identity has been verified by the third-party trust manager.

11. The apparatus of claim 10, wherein the processor-executable instructions comprises further instructions that causes the processor to:
encrypt the verification request with a public key associated with the third-party trust manager.

12. The apparatus of claim 10, wherein the processor-executable instructions comprises further instructions that causes the processor to:
digitally sign the verification request with a private key associated with an initiator of the blockchain transaction.

13. The apparatus of claim 12, wherein the processor-executable instructions comprises further instructions that cause the processor to:
pre-register the initiator with the third-party trust manager.

14. The apparatus of claim 13, wherein the processor-executable instructions that causes the processor to pre-register the transaction initiator comprises:
provide at least one identification credential belong to the initiator to the third-party trust manager before the initiator is permitted to send the blockchain transaction to the blockchain network.

15. The apparatus of claim 10, wherein the processor-executable instructions comprises further instructions that causes the processor to:
receive the verification response from the third-party trust manager indicating that the intended participant is not listed in a database of pre-verified entities; and
cancel the blockchain transaction in response to the verification response indicating that the intended participant is not listed in a database of pre-verified entities.

16. The apparatus of claim 10, wherein the processor-executable instructions comprises further instructions that causes the processor to:
send a status message to the intended participant indicating that verification of the intended participant is in progress.

17. The apparatus of claim 16, wherein the processor-executable instructions comprises further instructions that causes the processor to:
send a second status message to the intended participant after receipt of the verification response, the second status message indicating whether the intended participant was verified or not.

18. The apparatus of claim 10, wherein the verification response comprises a verification from a second third-party trust manager in communication with the third-party trust manager.

19. A system for verifying identities of participants of a blockchain transaction, comprising:
a personal communication device; and
a third-party trust manager;
wherein the system verifies a participant of a blockchain transaction by:
constructing a blockchain transaction by the personal communication device, the blockchain transaction comprising a non-verified identity of an intended participant of the transaction;
prior to sending the blockchain transaction to a blockchain network, sending a verification request to the third-party trust manager by the personal communication device, the verification request comprising the non-verified identifier of the intended participant;
receiving, by the third-party trust manager, the verification request from the personal communication device;
verifying, by the third-party trust manager, that the intended participant of the blockchain transaction is who the intended participant claims to be;
sending, by the third-party trust manager, a verification response comprising an indication whether or not the intended participant of the blockchain transaction is who the intended participant claims to be;
receiving the verification response by the personal communication device; and
sending the blockchain transaction to the blockchain network only when the verification response indicates that the intended participant's identity has been verified by the third-party trust manager.
